(19) United States
(12) Patent Application Publication
(10) Pub. No.: US 2026/0351147 A1
(43) Pub. Date: Nov. 5, 2026

(54) HEAD MOUNTED DISPLAY, DATA DISPLAY METHOD OF HEAD MOUNTED DISPLAY, AND HEAD MOUNTED DISPLAY SYSTEM

(71) Applicant: Maxell, Ltd., Kyoto (JP)

(72) Inventors: Naohisa TAKAMIZAWA, Otokuni-gun, Kyoto (JP); Yasunobu HASHIMOTO, Otokuni-gun, Kyoto (JP); Masuo OKU, Otokuni-gun, Kyoto (JP)

(21) Appl. No.: 19/487,004

(22) PCT Filed: Jun. 26, 2023
(86) PCT No.: PCT/JP2023/023548

§ 371 Date: Nov. 24, 2025

(51) Int. Cl. G09G 3/00; G06F 3/14

(52) U.S. Cl. CPC G09G 3/001; G06F 3/14; G09G 2354/00

(57) ABSTRACT

In the head mounted display that can be linked with information apparatus such as PCs, the user interface in position-free mode was not always appropriate. The user interface is improved by a head mounted display with a transparent screen that can be linked to an information processing apparatus comprising a memory unit storing data of an information processing apparatus in a viewing angle, a recognition unit that recognizes the information processing apparatus in the viewing angle, and a communication unit that receives the data from the information processing apparatus recognized by the recognition unit, and display unit displays the received data.

### TECHNICAL FIELD

The present invention relates to the data display of a head mounted display.

### BACKGROUND ART

The head mounted display (hereinafter referred to as HMD) displays a virtual image and allows the user wearing the HMD to experience the virtual reality space. The virtual space experience may be used by obtaining information on the cloud and using the HMD in a location-free manner, or by connecting the HMD with an information apparatus such as a personal computer (hereinafter referred to as a PC).

Patent document 1 of the prior art literature has a generative logic, a see-through display, and a presentation unit on a head mounted display, the generative logic is used to generate at least one virtual display, the presentation unit is used to present at least one virtual display on a see-through display, and the see-through display is configured to allow the user of the head mounted display to view at least one virtual display and a physical display in a real-world scene, at least one virtual display is presented on a see-through display as an additional object in the real-world scene, and at least one virtual display is disclosed, which is used in conjunction with a physical display of a computer system to display computer generated information in an extended desktop from the user's visual perspective, in conjunction with a physical display.

### CITATION LIST

### Patent Document

[Patent documents1] Japanese unexamined patent publication Tokuhyou No. 2017-510106

### SUMMARY OF THE INVENTION

### Problems to be Solved by the Invention

In patent document 1, HMD can be used as extended display for PC, but when HMD are used position-free, they are limited to use. In other words, patent document 1 states that when the HMD does not capture the PC's display, the display frame of the extended display (referred to as a virtual display in patent document 1) is maintained, and the information stored in the HMD is displayed on the display frame. However, no consideration is given to the decrease in operability of the HMD screen in position-free mode.

In HMD that can be linked to information apparatuses such as PC, the challenge is to realize a function that allows the HMD to be used in the position-free mode that does not require it to be used in a specific location.

The present invention is made in view of the above points, and the purpose of the invention is to realize optimal operation in an HMD that can be linked with information equipment, by switching the operation interface when switching to the position-free mode of the HMD.

### Solutions to Problems

The above problem is resolved by a head mounted display equipped with a transparent screen that can be linked to an information processing apparatus of the present invention. The head mounted display comprising a memory unit storing data stored in a memory of the information processing apparatus in a viewing angle, a recognition unit for recognizing the information processing apparatus in the viewing angle, a communication unit for receiving the data from the information processing apparatus recognized by the recognition unit, and a display unit for displaying the received data.

### Effects of the Invention

According to the present invention, a suitable user interface can be provided in an HMD that can be linked with an information apparatus.

### BRIEF DESCRIPTION OF THE DRAWINGS

FIG. 1 External view of the HMD in the embodiment of the present invention

FIG. 2 Functional block diagram of HMD in the embodiment of the present invention

FIG. 3 Diagram of the case of using the HMD as an extended display for a PC in the embodiment of the present invention

FIG. 4A Diagram of the use of HMD as an extended display for a PC in the embodiment of the present invention

FIG. 4B Example of a screen for selecting and copying information in the embodiment of the present invention

FIG. 4C Example of a screen for reading copy information in the embodiment of the present invention

FIG. 5 Illustration another example of a method of copying information in the embodiment of the present invention

FIG. 6 Diagram of the HMD used in position-free mode in the embodiment of the present invention

FIG. 7A Example of a screen illustrating a change in the user interface due to a mode change in the embodiment of the present invention

FIG. 7B Illustration the modification of the user interface due to the mode change in the embodiment of the present invention

FIG. 8 Block diagram composing an HMD using an information processing apparatus in the embodiment of the present invention

FIG. 9 Flowchart of the linked HMD program in the embodiment of the present invention

FIG. 10 Illustration of the transition of information display to a portable digital terminal in the embodiment of the present invention

FIG. 11 Block diagram of HMD corresponding to the body coordinate system display in the embodiment of the present invention

FIG. 12A Illustration of the virtual image of an HMD based on a body coordinate system display in the embodiment of the present invention

FIG. 12B Example of a screen illustrating the transition to a body coordinate system display in the embodiment of the present invention

FIG. 12C Illustration of the case of a narrow angle of view in the body coordinate system display in the embodiment of the present invention

FIG. 12D Illustration of the case in which the HMD is rotated in the body coordinate system display in the embodiment of the present invention

FIG. 13 Example flowchart showing how to display a virtual image in the embodiment of the present invention

### MODE FOR CARRYING OUT THE INVENTION

The embodiment of the present invention is described below, referring to the drawings.

### First Embodiment of the Present Invention

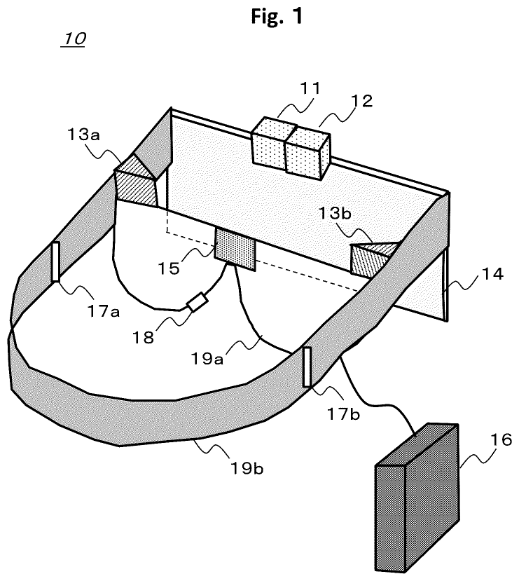

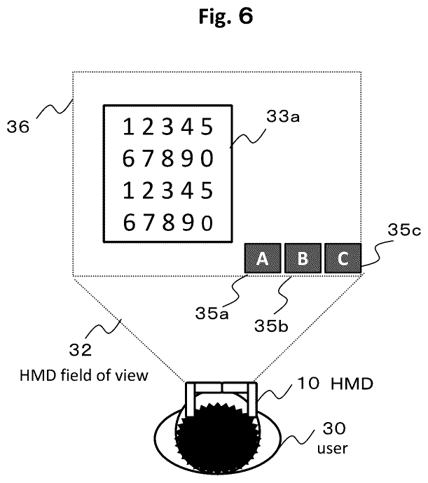

FIG. 1~FIG. 6 describes the first embodiment of an HMD that can be linked with information apparatuses.

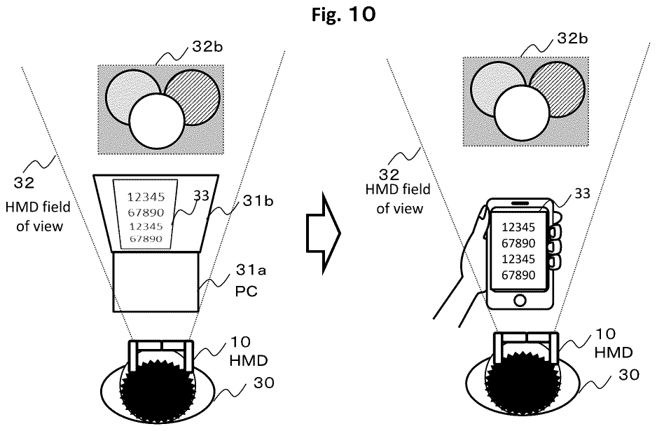

FIG. 1 is an external view of the HMD in the embodiment of the present invention. In FIGS. 1, 10 is HMD, 11 is camera, 12 is distance measurement unit, 13a, 13b is left and right pair of image projection units, 14 is screen, 15 is position and movement sensor group, 16 is control unit, 17a, 17b is left and right pair of speakers, 18 is microphone, 19a, 19b are mounting parts.

The user of the HMD (the experiencer of the virtual space) wears the HMD 10 on his head by the mounting parts 19a and 19b. The mounting part 19a supports the HMD at the nose of the face, and the mounting part 19b fixes the HMD around the head. The HMD 10 can be a spectacle-type HMD.

Camera 11 takes a picture of the front of the HMD. Control unit 16 takes the image of the camera, recognizes the real object from the camera image, and gives the depth data obtained from the distance measurement unit 12 to the real object to recognize the real object in three dimensions. Furthermore, projection units 13a and 13b generate a virtual image as a 2D or 3D image projected onto screen 14. In addition, speakers 17a and 17b create amplified sounds.

Projection units 13a, 13b and screen 14 make up the display part 19 of the HMD. The image of the virtual object seen by the left eye is projected onto screen 14 by projection unit 13a, and the image seen by the right eye is projected onto screen 14 by projection unit 13b, so that the virtual object appears to be at a predetermined distance in real space. If screen 14 is a translucent screen, the virtual image appears to be mixed in the real space seen through screen 14.

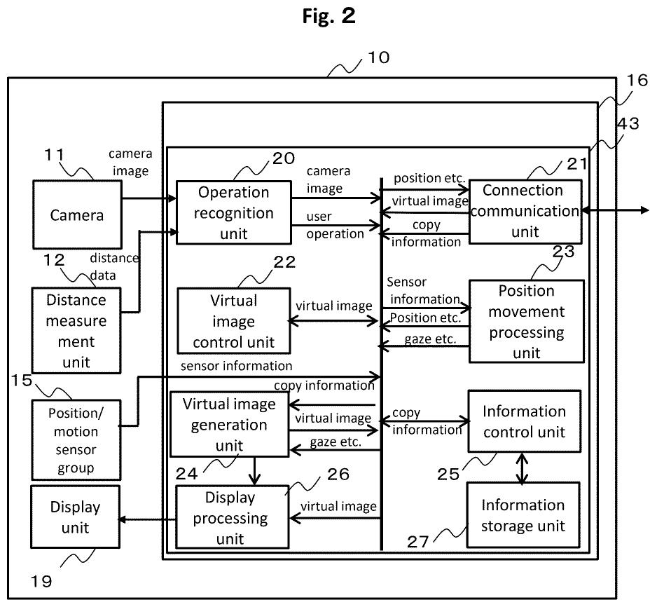

FIG. 2 is a functional block diagram of HMD 10 in the embodiment of the present invention, showing the details of the internal configuration of control unit 16. The same block as FIG. 1 has the same number. Furthermore, projection units 13a and 13b in FIG. 1 are combined to form 13, which together with screen 14 form display unit 19.

The control unit 16 in FIG. 2 has a memory unit (e. g. FROM) 43, an operation recognition unit 20, a connection communication unit 21, a virtual image control unit 22, a position movement processing unit 23, a virtual image generation unit 24, an information control unit 25, a display processing unit 26, and an information storage unit 27. In this embodiment, it is explained by an example that is realized by a software module stored in the memory part, but it can also be realized using hardware.

The operation recognition unit 20 receives camera images from the camera 11 and depth data from the distance measurement unit 12 as input, recognizes the user's fingers, arms, and other real objects captured by the camera images, and assigns depth data to the feature points of the real objects. In addition, the user's intended operation is recognized from the user's finger and hand movements.

The connection communication unit 21 connects to a PC and receives virtual images and copy information from the PC. It also supports communication protocols such as LAN and leads to the Internet etc. The position movement processing unit 23 determines the viewpoint of the HMD in terms of position and the line of sight of the HMD in terms f direction from the sensor signals of GPS, azimuth, and gyro sensors output by the position and motion sensor group 15.

Virtual image control unit 22 obtains the virtual image via the connection communication unit 21 and transmits it to the display processing unit 26. The information control unit 25 obtains the copy information via the connection communication unit 21 and stores it in the information storage unit 27. In addition, the copy information stored in the information storage unit 27 is read and transmitted to the virtual image generation unit 24. Virtual image generation unit 24 generates a virtual image to be sent to display processing unit 26 from the copy information. An example of the relationship between copy information and virtual image is that copy information is document data encoded image data, and virtual image is 2D or 3D image data for display generated from this data. Virtual images are generated to match the display shape, which changes based on the gaze of the HMD, and also have attributes related to the display position.

The display processing unit 26 transmits a virtual image from the virtual image control unit 22 or a virtual image generated by the virtual image generation unit 24 to the display unit 19.

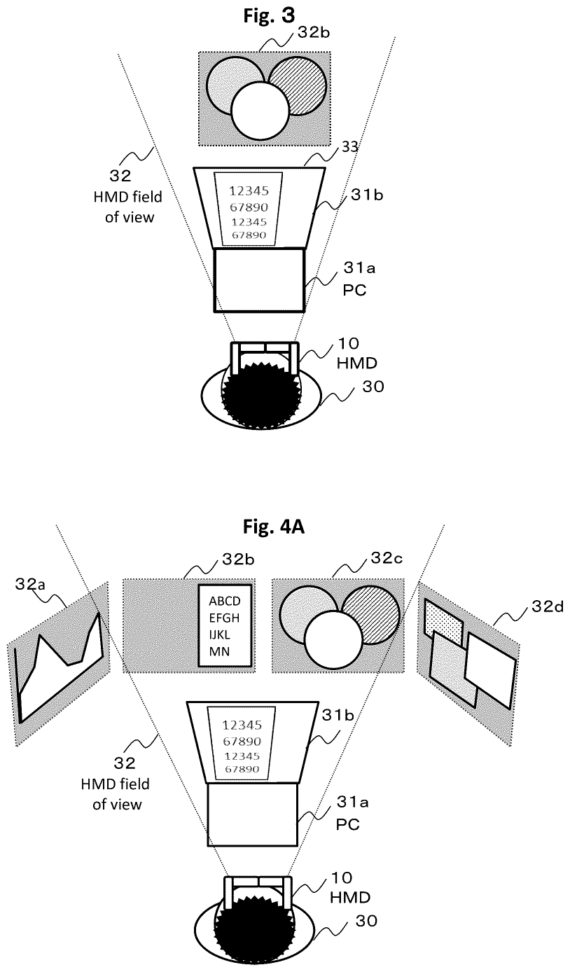

FIG. 3 is a diagram illustrating the case in which the HMD and the PC in the embodiment of the present invention are used in conjunction with the HMD as an extended display for a PC.

In FIGS. 3, 10 is HMD, 30 is user, 31a is PC, 31b is the physical display of the PC, 32b is a display frame that projects a virtual image (also referred to as a virtual display), and 32 is HMD field of view. PC 31a and physical display 31b may be in an integrated form as shown in the figure, or they may be separated from each other. PC 31a and HMD 10 are connected by wired connections such as USB and DisplayPort, or wireless LAN.

The PC 31a uses the display frame 32b displayed on the HMD 10's display as an extended display for the PC 31a. The PC 31a determines where to place the display frame 32b, how big it should be, and at what viewing angle, using the PC coordinate system with the PC 31a or the physical display 31b of the PC as the origin. The PC coordinate system is a coordinate system in which the virtual image maintains its position with the PC without following the motion Of the HMD when the user moves the HMD. PC 31a then sends a virtual image to HMD 10 for display frame 32b. The display frame 32b is recognized by PC 31a as a virtual display, which enables the PC 31a's multi-display system. PC 31a can display information on display frame 32b of HMD 10 in addition to physical display 31b, allowing the user to view and refer to more information briefly.

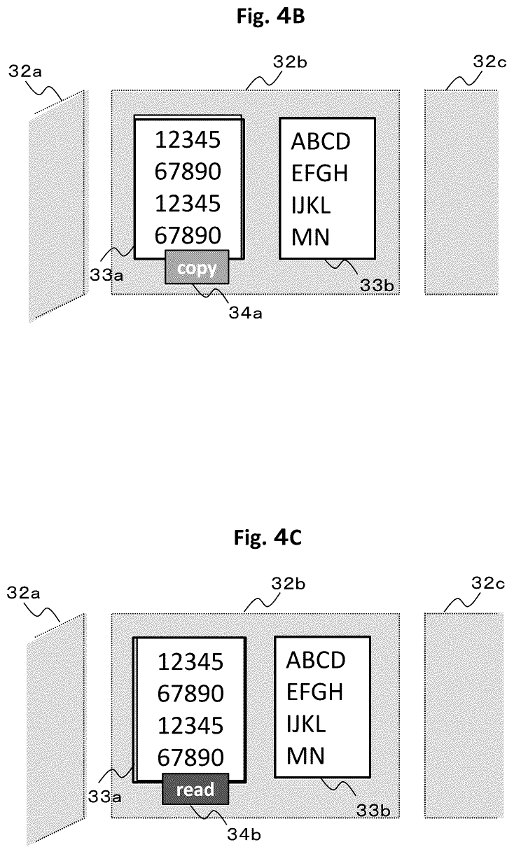

FIG. 4A shows an example of displaying multiple display frames of HMD 10 in the embodiment of the present invention. The field of view of HMD 10, or the range that can be displayed on the HMD 10's display, is limited, so the user can only see the virtual display frame within the field of view at that time. In the example of FIG. 4A, the user is facing forward, and display frames 32b and 32c inside the HMD field of view 32 are displayed on the HMD 10's display. The direction of the viewing angle changes to the left by the user turning his head to the left for example, and display frame 32a is displayed on the HMD 10's display. Similarly, if the user turns to the right, display frame 32d will be displayed on the HMD 10's display. In this way, the HMD 10's multiple display frames are displayed in the PC coordinate system mentioned above, so it is possible to achieve the same display as when multiple physical displays are placed in real space.

FIG. 4B and FIG. 4C are diagrams that illustrate the selection, storage, and read operation of information. In FIG. 4B and FIGS. 4C, 32a~32c is the same display frame as FIG. 4A. In addition, 33a and 33b are the virtual images projected on the display frame 32b, 34a is the operation button for operating information storage, and 34b is the reading button for indicating the state in which the information is stored and for reading.

FIG. 4B is a diagram in which the information in the embodiment of the present invention is selected and copied.

In FIG. 4B, when user 30 tries to copy and save virtual image 33a to HMD 10, for example, by manipulating the pointing apparatus of PC 31a, the user selects the virtual image of virtual image 33a by left clicking, and displays the operation button 34a with a right click operation. Furthermore, if the user presses operation button 34a with a left click operation, the virtual image 33a will be copied from PC 31a to HMD 10. When the copy is executed, operation button 34a switches to read operation button 34b, as shown in FIG. 4C. This copy operation is not limited to one piece of information but can be in a state where multiple pieces of information are copied by selecting multiple pieces of information and press button at the same time, or by repeating the copying of information one by one.

FIG. 4C is a diagram that reads out the copy information in the embodiment of the present invention. To switch the HMD 10 from linkage mode with the PC 31a to the position-free mode and view the information at a distance from the PC, from the state of FIG. 4C, the user operates the HMD 10 and presses the read operation button 34b. At this time, the HMD automatically transitions to position-free mode.

For example, when maintenance workers perform maintenance on plants, etc., the maintenance workers cause the HMD to display the instruction information of plant equipment. In the PC linkage mode, a huge amount of information is displayed on the display of the PC itself and the extended display of the HMD, and the user operates the PC to select the necessary equipment instructions while viewing the displayed image, and copies the information of the selected instruction to the HMD. When the HMD moves to the position-free mode, the user can directly manipulate the HMD to generate and display a virtual image of the copied information. This allows users wearing HMD to move to plant equipment at a distance from the PC and operate the equipment while viewing the virtual image.

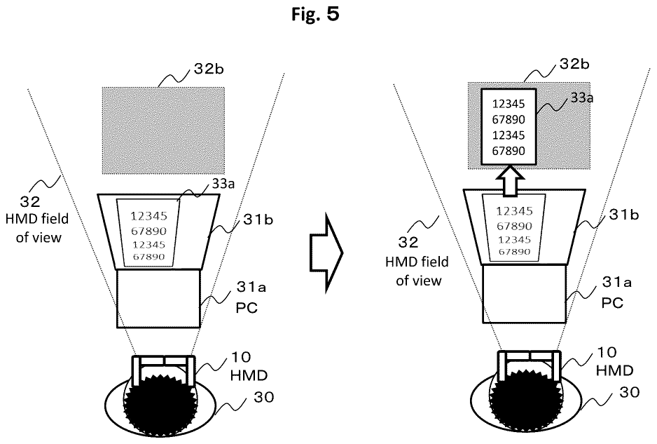

FIG. 5 is an illustration of another example of copying and storage of information in the embodiment of the present invention. Here is an example of user 30 displays virtual image 33a on display frame 32b displayed by HMD 10. The user operates the PC 31a's pointing apparatus, etc., and drags the virtual image of the virtual image 33a displayed on the physical display 31b while selecting the image by left click, and move it to the display frame 32b. At this time, the virtual image 33a is displayed on the display frame 32b, and at the same time, the virtual image 33a is copied to HMD 10 and saved, and the subsequent display is performed by the HMD. By moving the information display to the display frame and copying and saving the information at the same time, it has the advantage of making it easier to understand the location of the information compared to the instructions given by button operation.

FIG. 6 is a diagram the case in which HMD 10 is used in position-free mode in the embodiment of the present invention. In FIG. 6, HMD 10, user 30, and HMD field of view 32 are the same as in FIG. 4, but 36 indicates the visible virtual space range of the HMD (the range is not actually displayed) , and the virtual image generated from the virtual image 33a read out in FIG. 4C is displayed within the visible virtual space range 36. HMD 10 is in position-free mode, and the virtual image is displayed in a local coordinate system starting from HMD 10. From hereafter, the local coordinate system starting from HMD 10 is written as the HMD coordinate system.

At this time, the display position and size can be set by user operation. In the HMD coordinate system, when the user moves the HMD, the virtual image tries to maintain its position with the HMD, so the position of the virtual image in the virtual space does not change. It is also possible to switch and display the stored copy information, and it is done by pressing the information selection button 35a, 35b, and 35c that represent the stored copy information. Operations other than information selection are also possible, and HMD 10's user operations may cause the HMD to display multiple information at the same time, control the overlap of displays, and turn pages of information, and the like.

If the user switches the HMD to position-free mode and moves to a place away from the PC, the user cannot use the pointing device on the PC side through the HMD, so performs operations by gesture input using the camera installed in the HMD. Compared to the PC pointing device, the gesture input is difficult to specify detailed positions on the screen. In addition, pointing devices connected to a PC do not have multiple physical buttons that are generally available, so there are fewer variations in operation. This makes it difficult to enter data while the display remains the same as in PC connection mode. Therefore, in position-free mode, the screen operation interface is provided with an interface suitable for gesture input, etc.

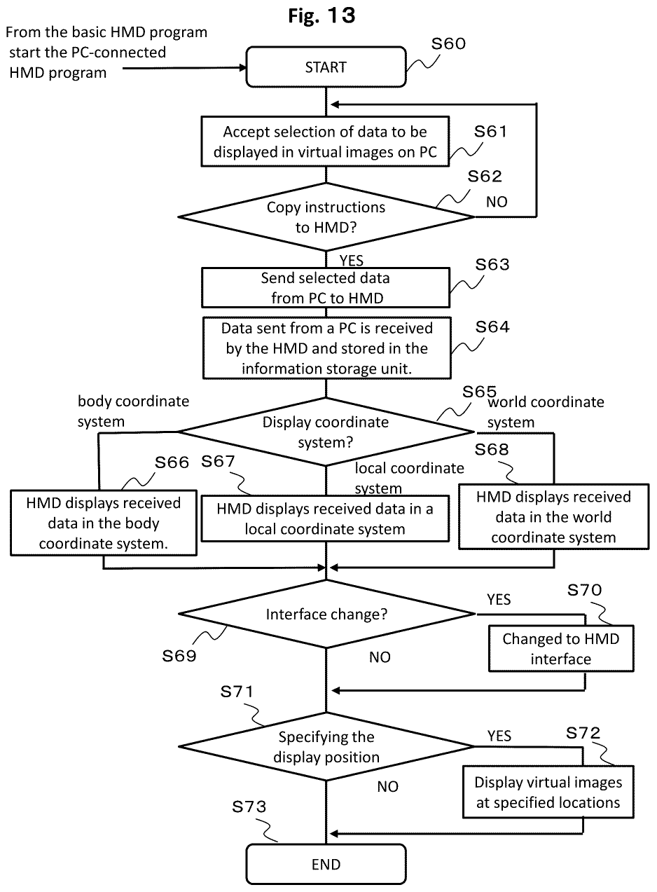

Interface changes can be determined, in step S69 of FIG. 13, by accepting the user's instructions by operation recognition unit 20, or based on the image obtained from the camera, whether the PC is within the viewing angle of the image.

Interface changes can also be changed based on what is selected as the display coordinate system. For example, if the world coordinate system is selected, it provides an interface that displays buttons of the minimum size necessary suitable for PC operation, and if other local coordinate systems and body coordinate systems are selected, it provides an interface that displays large buttons, etc. suitable for HMD operation, making it a system with good operability with few interface switches by manual operation.

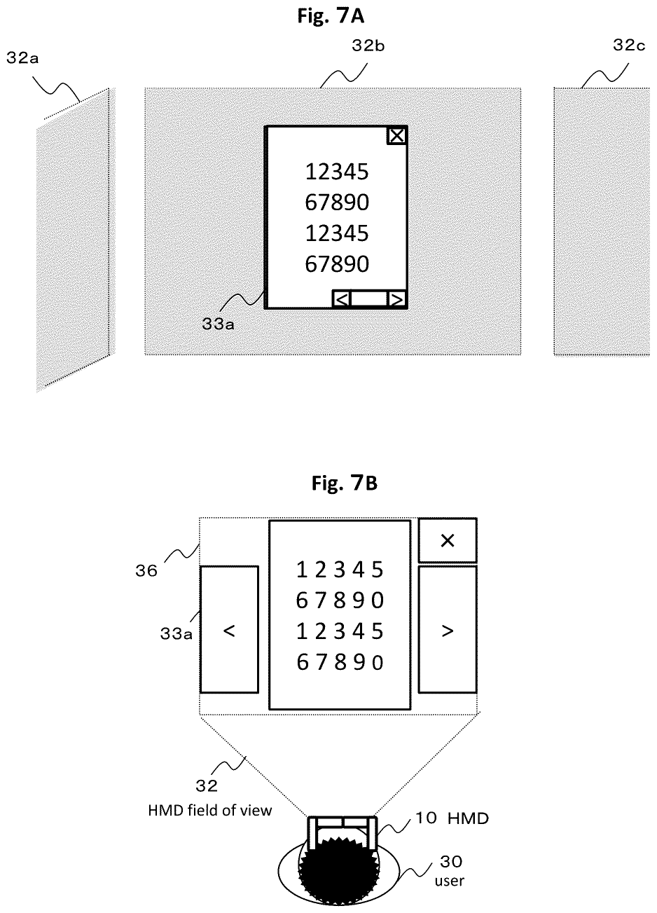

FIG. 7A and FIG. 7B are diagrams illustrating the user interface change when the mode is changed in the embodiment of the present invention. For example, as in FIG. 7A, when in PC linkage mode, the visibility of virtual image 33a is prioritized, and buttons are displayed smaller. In position-free mode, the buttons are changed to make them easier to press with gestures by displaying them larger as in FIG. 7B, or by opening the distance between the buttons.

Switching interfaces can be done at the same time as switching to position-free mode. In addition, after switching to position-free mode, various sensors can detect that it is more than a certain distance away from the PC and switch the display. By displaying a button for switching, etc., the user can manually switch the display by pressing the button.

Switching interface is like the process in step S69 of the flowchart in FIG. 13, and the virtual image generation unit 24 generates a virtual image with the interface modification by accepting the change instruction in operation recognition unit 20.

As explained above, according to the first embodiment of the present invention, a function of using the HMD in a position-free manner can be provided in an HMD that can be linked with an information apparatus. In the position-free mode provided, it is possible to display a virtual image that is not restricted by the display frame when linking information equipment, and it is characterized by being easy to operate the HMD alone by switching to a screen suitable for input operation by the HMD alone according to the mode switching.

### Second Embodiment of the Present Invention

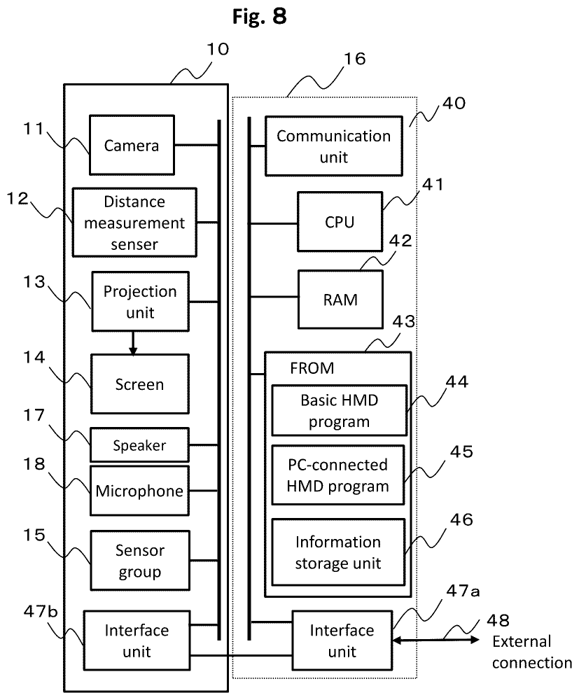

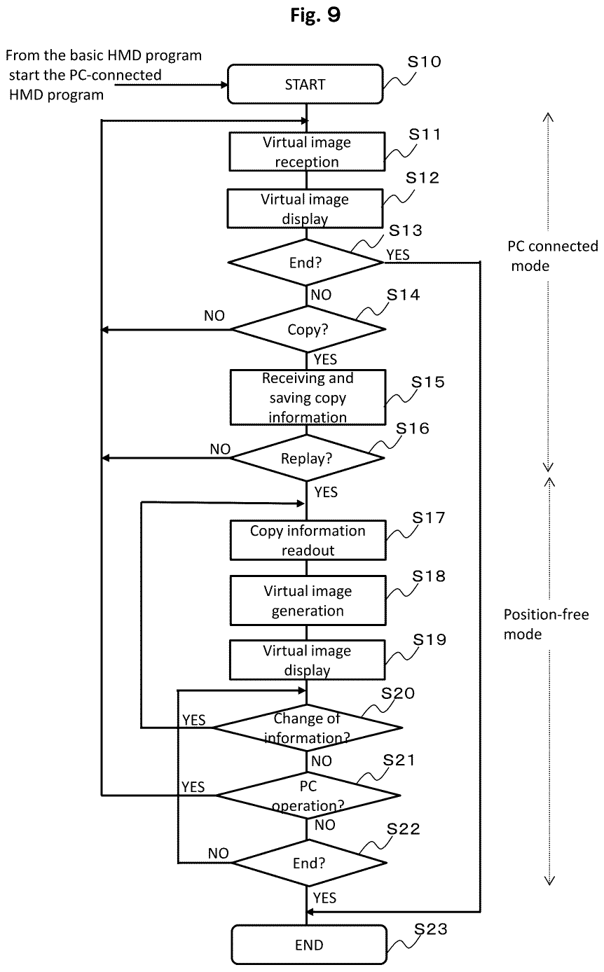

FIG. 8 and FIG. 9 describe the second embodiment.

FIG. 8 is a block diagram composing an HMD using an information processing apparatus in the embodiment of the present invention. HMD 10 comprises an HMD alone in Example 1, but in Example 2, it comprises an HMD and an information processing apparatus that is separate from the HMD. The difference from the functional block diagram in FIG. 2 is that the control unit 16 is configured as an information processing apparatus, and it has the advantage of being able to use general-purpose devices such as smartphones, which are portable terminals, as information processing apparatuses.

In FIG. 8, the same number is given to the same as FIG. 1 and FIG. 2. In FIG. 8, control unit 16 includes communication unit 40, CPU (Central Processing Unit) 41, RAM (Random Access Memory) 42, FROM (Flash Read Only Memory) 43, and interface unit 47a. The interface unit 47a is connected to the interface unit 47b located in the main body of the HMD. In addition, it is responsible for external connections and can be used to connect to PCs. The interfaces realized by interface units 47a and 47b can be wired or wireless, for example, USB. Also, although not illustrated, control unit 16 may include an interface unit such as a display part or a touch panel like a regular smartphone.

Communication unit 40 of the control unit 16 can connect the HMD 10 to the network or connect it to a PC by selecting the appropriate processing from several communication processes such as mobile communication such as 4G and 5G, and wireless LAN (Local Area Network). In addition, FROM 43 includes basic HMD program 44, PC-connected HMD program 45, and information storage unit 46 as processing programs. Processing programs 44 and 45 are deployed to RAM 42 and run on CPU 41. In addition, the information storage unit 46 temporarily stores the intermediate data necessary to execute the processing program, as well as the copy information obtained from the PC. FROM 43 can be configured with a single memory medium or multiple memory medium. Furthermore, it can be a non-volatile memory medium other than FROM.

FIG. 9 is an example of a flowchart of a collaborative HMD program in the embodiment of the present invention. When the PC's multi-display system is run in the basic HMD program, the PC-connected HMD program 45 is started and processing begins from S10.

Receive a virtual image from the PC in S11. The virtual image is given the corresponding display frame information, and the virtual image is displayed in S12. Check the termination conditions of the program in S13 (such as PC stopping the multi-display system), and if it ends (YES), it will end in S23, but if it continues (NO), check the waiting for the execution of the copy of information in S14, if there is no wait to execute the copy operation (NO), return to the step of S11, and if there is a wait for the execution of the copy operation, receive and save the copy information in S15. The steps up to S11~S16 are in PC linkage mode.

In S16, check whether there is a playback operation for copy information by HMD operation, return to the S11 step if it is not operated (NO), enter position free mode when the playback operation is performed (YES), and read the copy information in S17. Generate a virtual image of copy information in S18 and display a virtual image in S19. There are no restrictions on the display of virtual images within the viewing range of the HMD, and the image to be generated by user operation can be specified.

Accept instructions to change the copy information to be played in S20, return to the S17 step if the change is to be made (YES), and check the PC operation in the S21 if the change is not made (NO). If the PC operation exists (YES), return to the S11 step to transition from position-free mode to PC linkage mode, if there is no PC operation performed (NO), check the termination conditions in S22, and if it ends (YES), end in S23. If it continues (NO), go back to the S20 step.

FIG. 10 is a diagram illustrating the transition of information display to a portable information terminal in the embodiment of the present invention. This is an example of displaying information displayed on a PC in position-free mode on a display apparatus of the portable information terminal that is movable.

When switching to position-free mode, it is possible to perform the display and operations that were previously performed on a PC using a smartphone, which is a portable mobile terminal. Specifically, the information displayed on the PC screen is copied to the information displayed on the smartphone and displayed on the smartphone screen. When displaying information displayed on a PC on a smartphone, if necessary, launch the application used to display the information on the smartphone side before displaying the information.

In addition, operations that were performed on an input operation interface of the PC are performed on the touch panel of the smartphone, etc. As in PC connection mode, the user can use the touch panel of the smartphone to perform operations such as cursor and button presses in the virtual frame displayed on the HMD. By using the touch panel of the smartphone as a pointing device, it is possible to operate in a more detailed way than the operation by gesture input on the HMD alone. The smartphone and the touch panel installed in the smartphone were given as examples, but if the use of a mobile terminal and its input interface makes it easier to operate with the HMD alone, then the type of terminal and the type of input interface do not matter.

As explained above, according to the second embodiment of the present invention, it has the same effect as the first embodiment, and is characterized by being able to provide convenience like that of a PC linkage mode even at a mobile destination by carrying a versatile information processing apparatus instead of a PC.

### Third Embodiment of the Present Invention

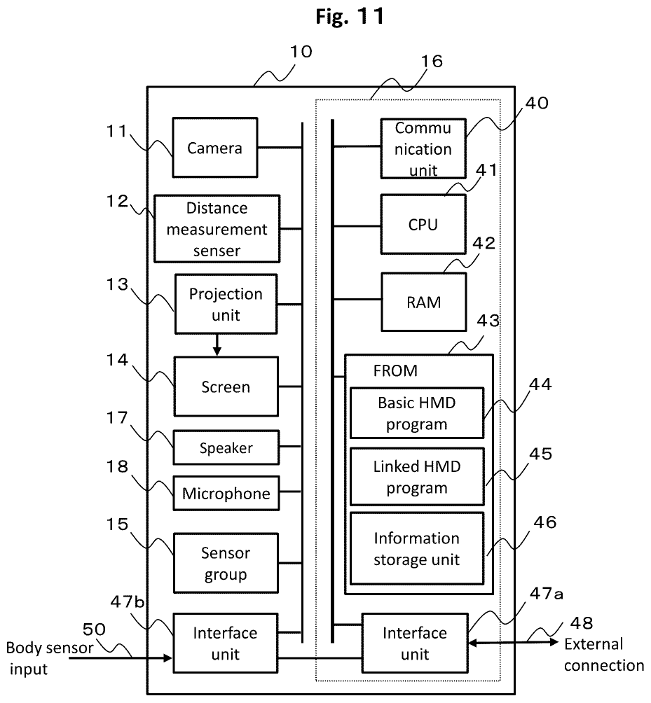

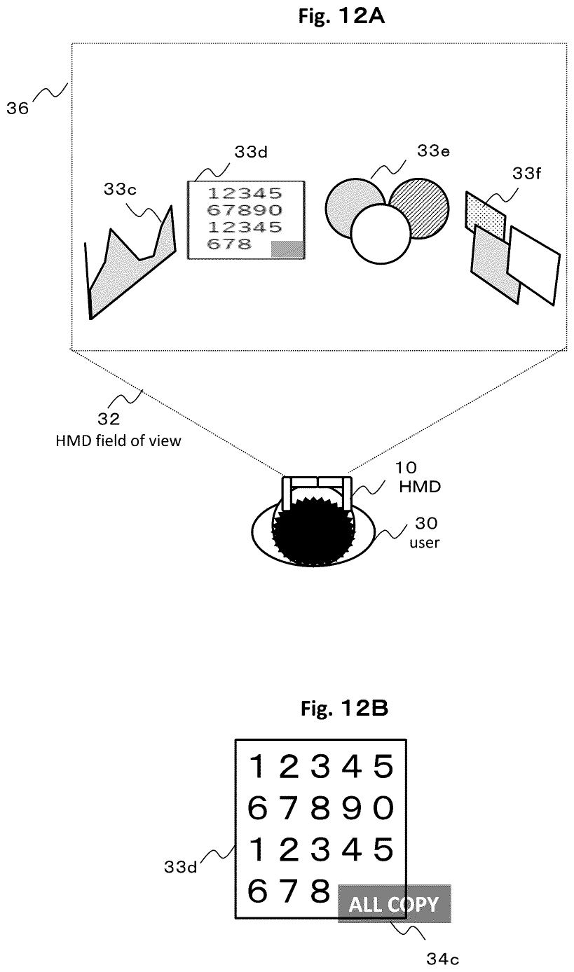

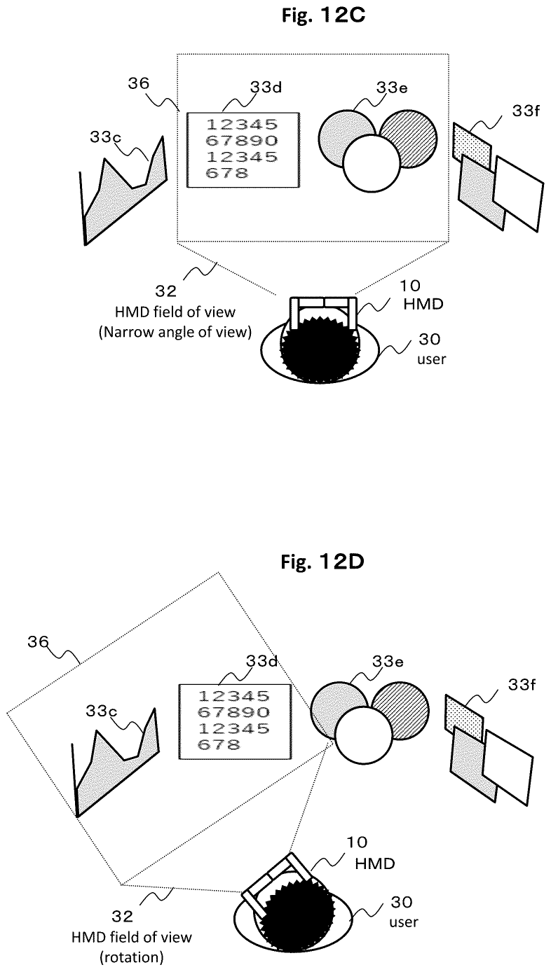

Next, FIG. 11 and FIG. 12A~D describe the third embodiment.

The process flow of the third embodiment is described with reference to the example of the flowchart showing how the virtual image is displayed in the embodiment of the present invention in FIG. 13.

The third embodiment of the present invention uses a body coordinate system originating from the body of the user with the body sensor attached, in the position free mode. The virtual image placed in the body coordinate system is fixed relative to the position and orientation of the user's body, and the virtual image can be looked around by the user's head shake and other motions of the HMD separated from the user's body.

FIG. 11 is a block diagram of an HMD corresponding to the body coordinate system in the embodiment of the present invention. The only difference is that the body sensor input 50 is input to interface unit 47b compared to the block diagram in FIG. 8. The body sensor input 50 calculates the orientation of the body from the difference in the output of the sensor mounted on the body and the sensor mounted on the HMD, for example, and inputs it to the HMD. In addition, the camera mounted on the HMD can determine the orientation of the user's body and use it as body sensor input information. FIG. 12A~D is a diagram illustrating the virtual image of the HMD placed in the body coordinate system.

FIG. 12A is a diagram illustrating the virtual image of an HMD based on a body coordinate system in the embodiment of the present invention. HMD 10, user 30, HMD field of view 32, and HMD's visible virtual space range 36 are identical to those already described. Virtual images 33c~33f are placed in the body coordinate system and displayed in visible virtual space range 36. FIG. 12A shows the state of HMD 10 shortly after it has moved from PC linkage mode to position-free mode, but the transition to position-free mode is performed in the example screen shown in FIG. 12B.

In the transition process from PC linkage mode to position-free mode, the operation recognition unit 20 determines the image received from camera 11, and the process of step S65 is performed to determine the change of the display coordinate system based on whether the PC is in the field of view or not. This judgment can be performed by pressing the button that instructs the coordinate system change displayed in the virtual image of the HMD. In addition, the coordinate system to be migrated can be a coordinate system such as a world coordinate system, a local coordinate system, or a body coordinate system.

FIG. 12B is a diagram illustrating the transition to a body coordinate system in the embodiment of the present invention. For example, PC 31a's pointing device is operated to display the entire save operation button 34c in the visible virtual space range 36. In FIG. 12B, it is superimposed on virtual image 33d. Furthermore, when the operation button 34c is pressed by an operation of HMD 10, the information corresponding to virtual images 33c~33f is copied from PC 31a to HMD 10 and saved. At the same time, the HMD 10 will move into position-free mode. In position-free mode, as shown in FIG. 12A, virtual images 33c~33f are displayed even if the physical display 31b of the PC is out of the viewing range of HMD 10. This is because the data of the virtual image for the display of virtual images 33c~33f is in the HMD 10. Virtual images 33c~33f are maintained throughout the body coordinate system and is maintained even when outside the visible virtual space range.

FIG. 12C is a diagram illustrating the case of a narrow angle of view in the body coordinate system in the embodiment of the present invention. Within the visible virtual space range 36 corresponding to the field of view 32 that has the narrow angle of view, virtual images 33d and 33e are displayed, and the user 30 can view the enlarged virtual images 33d and 33e.

The selection of the narrow angle of view can provide a virtual image that follows the user's request by accepting the operation recognition unit 20 together with the change of the coordinate system in step S65 processing.

FIG. 12D is a diagram illustrating the case in which the HMD is rotated in the body coordinate system in the embodiment of the present invention. FIG. 12D describes the case of rotating HMD 10 from the state of FIG. 12C. Virtual images 33c and 33d are displayed in visible virtual space range 36, which corresponds to the field of view 32 having a narrow angle of view and being rotated. In FIG. 12C and FIG. 12D, the virtual image with displacement in the body coordinate system is regenerated using the corresponding information stored. By moving the head wearing the HMD 10, the user can look around at the virtual image that is fixed to the world coordinates and regenerated at the end of the user's line of sight, so the user can see more information than the actual display area of the HMD 10.

When the HMD is rotated, the virtual image is displayed based on the display position specified in step S71, with the origin defined as the reference point for rotation.

Furthermore, by copying the information displayed on the physical display to the virtual display in PC connection mode, it is possible to perform the same operations as viewing on a PC from a different location. The position of each virtual display relative to the body remains unchanged even in a different location, eliminating the need to re-memorize the configuration position and enabling efficient work.

As explained above, according to the third embodiment, it has the characteristics of the first and second embodiments, and has the effect of preventing the user's work efficiency from deteriorating even if it is moved from PC linkage mode to position-free mode.

In addition, the embodiments of the present invention described in FIG. 1 to FIG. 13 are not limited to these, and it is possible to replace a part of the composition of one embodiment with another embodiment. It is also possible to add the composition of another embodiment to the composition of one embodiment. All of these belong to the category of the present invention, and the numbers and messages that appear in sentences and diagrams are only examples, and the use of different things does not impair the effect of the present invention.

In addition, some or all of the functions of the invention may be implemented in hardware, for example, by designing them in integrated circuitry. It can also be implemented with software that interprets and executes operating programs such as microprocessor units and CPU. In addition, it does not limit the scope of software implementation, and hardware and software can be used together.

### REFERENCE SIGNS LIST

10: Head mounted display (HMD)
11: Camera
12: Distance measurement unit
13a, 13b: Projection unit
14: Screen
15: Sensor group
16: Control unit
20: Operation recognition unit
21: Connection communication unit
22: Virtual image control unit
23: Position movement processing unit
24: Virtual image generation unit
25: Information control unit
26: Display processing unit
27: Information storage unit
30: User
31a: PC
31b: Physical display
32: HMD field of view
32a~32d: Display frame
33a~33f: Virtual image
34a~34c: Operation button
35a~35c: Information selection button
36: Visible virtual space range
41: CPU
43: FROM
44: Basic HMD program
45: PC-connected HMD program
47a, 47b: Interface unit
50: Body sensor input

1. A head mounted display with a transparent screen that can be linked to an information processing apparatus comprising:
a recognition unit configured to recognize the information processing apparatus in a viewing angle of the head mounted display,
a communication unit configured to receive data from the information processing apparatus recognized by the recognition unit,
a memory unit configured to store the data received by the communication unit, and
a display unit configured to display the data stored by the memory unit.

2. The head mounted display according to claim 1, further comprising:
an interface processing unit configured to accept a processing of the data by a first interface when the recognition unit determines that there is the information processing apparatus in the viewing angle of the head mounted display, and accept a processing of the data by a second interface when the recognition unit determines that there is not the information processing apparatus in the viewing angle of the head mounted display.

3. The head mounted display according to claim 1, wherein
when the recognition unit determines that there is the information processing apparatus in the viewing angle of the head mounted display, the display unit displays the data in a coordinate system corresponding to the information processing apparatus, and
when the recognition unit determines that there is not the information processing apparatus in the viewing angle of the head mounted display, the display unit displays the data in a coordinate system corresponding to the head mount display.

4. The head mounted display according to claim 3, further comprising:
an image generation unit configured to, when the recognition unit accepts an instruction to change a coordinate system, generate a virtual image of the data stored in the memory unit based on the accepted coordinate system, and
wherein the display unit displays the generated virtual image.

5. The head mounted display according to claim 3, further comprising:
an image generation unit configured to, when the recognition unit accepts an arbitrary position in a visible virtual space of the head mounted display, generate a virtual image of the data stored in the memory unit based on the accepted arbitrary position, and
wherein the display unit displays the generated virtual image.

6. The head mounted display according to claim 1,
wherein the display unit displays data in a body coordinate system originating from a user's body if there is not the information processing apparatus in the viewing angle of the head mounted display.

7. The head mounted display according to claim 6,
wherein the display unit displays data stored in the memory unit when detecting predetermined motion of the head mounted display.

8. A data display method of a head mounted display with a transparent screen that can be linked to an information processing apparatus, comprising:
recognizing, by a recognition unit, an information processing apparatus located in a viewing angle of the head mounted display,
receiving, by a communication unit, data from the recognized information processing apparatus,
storing, by a memory unit, the received data,
displaying, by a display unit, the stored data.

9. A head mounted display system with a transparent screen that can be linked to an information processing apparatus comprising:
a portable terminal, and
a head mount display,
wherein the portable terminal comprising:
a recognition unit that recognizes the information processing apparatus in a viewing angle of the head mounted display,
a communication unit receiving data from the information processing apparatus recognized by the recognition unit,
a memory unit storing the data received by the communication unit, and
wherein the display unit that displays the data stored by the memory unit.
